(19) United States
(12) Patent Application Publication
(10) Pub. No.: US 2017/0266875 A1
(43) Pub. Date: Sep. 21, 2017

(54) SEAM FORMING SYSTEM AND PRODUCTION METHOD

(71) Applicant: Nemo Equipment, Inc., Dover, NH (US)

(72) Inventor: Camon Brensinger, Stratham, NH (US)

(21) Appl. No.: 15/463,550

(22) Filed: Mar. 20, 2017

Related U.S. Application Data
(60) Provisional application No. 62/310,983, filed on Mar. 21, 2016.

(51) Int. Cl. B29C 65/00; B29C 65/14; B29C 65/48; B29C 65/08

(52) U.S. Cl. CPC B29C 66/439; B29C 65/08; B29C 65/1403; B29C 65/4805; B29C 65/4895; B29L 2022/02

(57) ABSTRACT

A system and method for forming a seam in at least one piece of material used to form an inflatable product utilizes a seam forming member that is attached to an inside wall of a piece of product material that comprises the inflatable product. The inflatable product is comprised of one or more pieces of product material and one or more seam forming members located at any location where a seam is necessary. A first portion of the seam forming member attaches to a first edge of a first piece of product material and a second portion of the seam forming member attaches proximate a second edge of the first piece of product material. The seal forming means can be accomplished by radio frequency, ultrasonic, heat or other types of welding, and adhesive or chemical based bonding.

### CROSS-REFERENCE TO RELATED APPLICATIONS

This application claims priority from U.S. Provisional Patent Application No. 62/310,983, titled “Seam Production Method”, which was filed on Mar. 21, 2016 and is incorporated fully herein by reference.

### TECHNICAL FIELD

The present invention relates to a seam forming system and method for welding, gluing or otherwise joining two pieces together and more particularly, relates to a high-strength sheer-type seam method that can be used with heat weldable materials or adhesives used in the manufacture of various products including inflatable products.

### BACKGROUND INFORMATION

Inflatable products such a tubes, etc. are typically made from low cost plastic or PVC type material that is generally heat weldable. This facilitates a high volume, low cost production method. Typically, the design of such products requires at least one seam. These seams are exposed to extreme internal and external pressure and stress once they are inflated and have been the source of air leaks, complete failure and other damage to inflatable products. Repairing a damaged seam is often difficult or impossible and repaired seams generally do not hold up as long as original seams. Accordingly, what is needed is a new method of welding a seam that resists separation and that has high burst strength.

### SUMMARY OF THE INVENTION

The invention features, in one embodiment, a seam forming system, for use in joining first and second edge regions of at least a first piece of product material. The seam forming system comprises at least a first planar seam forming member having a first side and a second side and a first end and a second end. A portion of the first side of the at least a first planar seam forming member proximate the first end is configured for forming a seam joint between the portion of the first side proximate the first end of the at least a first planar seam forming member and a first edge region of the at least a first product material. A portion of the first side of the at least a first planar seam forming member proximate the second end is configured for forming a seam joint between the portion of the first side of the at least a first planar seam forming member proximate the second end of the at least a first planar seam forming member and a second edge region of the at least a first product material.

The seam forming system may further include a second piece of product material and a second planar seam forming member. The second planar seam forming member has a first side and a second side and a first end and a second end. A portion of the first side of the second planar seam forming member proximate the first end is configured for forming a seam joint between the portion of the first side proximate the first end of the second planar seam forming member and a first edge region of the second piece of product material, while a portion of the first side of the second planar seam forming member proximate the second end is configured for forming a seam joint between the portion of the first side of the second planar seam forming member proximate the second end of the second planar seam forming member and a second edge region of the second piece of product material.

The seam joint between the portion of the first side proximate the first end of the at least a first planar seam forming member and a first edge region of the at least a first product material and the seam joint between the portion of the first side of the at least a first planar seam forming member proximate the second end of the at least a first planar seam forming member and a second edge region of the at least a first product material and between the portion of the first side proximate the first end of the second planar seam forming member and a first edge region of the second product material and the seam joint between the portion of the first side of the second planar seam forming member proximate the second end of the second planar seam forming member and a second edge region of the second product material are formed from a method selected from the group of seal forming methods consisting of radio frequency, ultrasonic, heat or other types of welding, and adhesive or chemical based bonding.

The invention also features a seam joining method for use in joining a first edge and a second edge of material to be joined together. The seam joining method comprises the acts of providing at least a first planar seam forming member having a first side and a second side and a first end and a second end. A portion of The first side of the at least a first planar seam forming member proximate the first end is configured for forming a seam joint between said portion of the first side proximate the first end of the at least a first planar seam forming member and a first edge region of the at least a first product material. A portion of the first side of the at least a first planar seam forming member proximate the second end is configured for forming a seam joint between the portion of the first side of the at least a first planar seam forming member proximate the second end of the at least a first planar seam forming member and a second edge region of the at least a first product material.

The method includes joining the first end of the at least a first planar seam forming member to the first edge region of the at least a first product material and joining the second end of the at least a first planar seam forming member to the second edge region of the at least a first product material.

The seam joining method includes the act of joining the seam joining element to the first and second end of the at least a first product member by means of heat welding, ultrasonic welding or utilizing an adhesive.

The seam joining method further includes the act of providing a second piece of product material and a second planar seam forming member. The second planar seam forming member has a first side and a second side and a first end and a second end. A portion of the first side of the second planar seam forming member proximate the first end is configured for forming a seam joint between the portion of the first side proximate the first end of the second planar seam forming member and a first edge region of the second piece of product material while a portion of the first side of the second planar seam forming member proximate the second end is configured for forming a seam joint between the portion of the first side of the second planar seam forming member proximate the second end of the second planar seam forming member and a second edge region of the second piece of product material.

The method further includes joining the first end of the second planar seam forming member to the first edge of the second edge region of the second piece of product material and joining the second end of the second planar seam forming member to the second edge of the second piece of product material.

### BRIEF DESCRIPTION OF THE DRAWINGS

These and other features and advantages of the present invention will be better understood by reading the following detailed description, taken together with the drawings wherein:

FIG. 1A is a detailed view of the seam method according to the present invention prior to inflation;

FIG. 1B is a detailed view of the weld method after inflation; and

FIG. 1C is a detailed view of two weld members as contemplated by of one embodiment of the present invention.

### DETAILED DESCRIPTION OF THE PREFERRED EMBODIMENTS

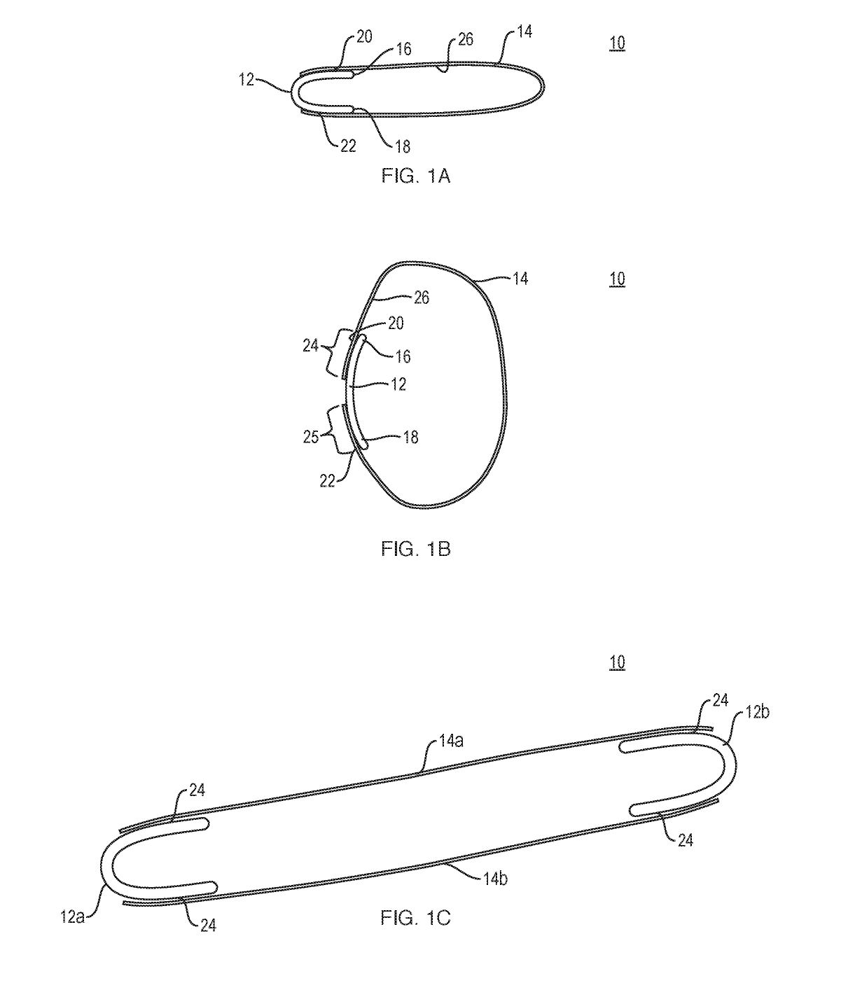

In the preferred embodiment of the present invention, FIGS. 1A and 1B, an improved seam forming method and a seam forming element is shown for an inflatable product 10 that comprises a seam forming element 12, which is configured to attach to an inside wall 26 of a piece of inflatable product material 14 that comprises the inflatable product 10. The seam forming element 12 is flexible and preferably of the same or similar material as the inflatable product material 14 that comprises the inflatable product 10. The seam forming element 12 includes a first end 16 for attachment to a first portion 20 of the inflatable product material 14 and a second end 18 for attachment to a second portion 22 of the inflatable product material 14. The inflatable product material 14 can be any flexible plastic or laminate material, such as what is typically used for inflatable products.

The first portion 20 of the inflatable product material attaches at an attachment area 24 to the first end 16 of the seam forming element 12 by way of any suitable seal forming method including but not limited to radio frequency, ultrasonic, heat or other types of welding, and adhesive or chemical based bonding, while the second portion 22 of the inflatable product material attaches at an attachment area 25 to the second end 18 of the weld member 12 also by way of any suitable seal forming method as set forth above. Other methods of attaching the two materials together are contemplated and within the scope of the invention. The attachment areas 24, 25 preferably cover the entire portion of the contact area between the weld member 12 and the inflatable product material ends 20, 22.

As shown in FIG. 1A, when the inflatable product 10 is deflated, the seam forming element 12 can lay flat or form a “C” shape. In this deflated condition, the seam forming element 12 and the end regions 20, 22 of the inflatable member 10 are in a “peel” attachment state meaning the ends of the attachment material/regions 20, 22 could be relatively easily “peeled” off or away from the seam forming element 12.

However, once the inflatable product 10 is inflated, FIG. 1B, the seam forming element 12 conforms to the desired shape of the inflatable product 10. The seam is such that the air pressure on the inside of the inflatable product places the seam formed by the seam forming element 12 and the end regions 20, 22 of the inflatable member 10 in “sheer”, creating a seam that cannot be easily torn apart or separated, and is much more resistant to seam delamination and failure than a traditional “peel” type seam arrangement. The seam method of the present invention is superior over seam methods currently used with inflatable products.

It is contemplated by this invention that one or more seam forming elements 12 could be used at the same time. For example, two seam forming elements 12a, 12b may be utilized. In this example, FIG. 1C, two pieces of inflatable product material 14a, 14b, are used. The attachment means and methods utilized with two or more weld members are the same as described above for FIGS. 1A and 1B.

The invention describes a method of seaming inflatable products in order to utilize a simple welding production method that is low cost, but creates a high strength sheer-type seam when the final product is inflated. The seam forming method allows for the affordable manufacturing of very lightweight inflatable products that can be composed of laminate fabrics, but which have high burst strength.

It is also contemplated by this invention that this seam method may be used with other products and with other materials and in other fields outside the field of inflatable products.

Modifications and substitutions by one of ordinary skill in the art are considered to be within the scope of the present invention, which is not to be limited except by the allowed claims and their legal equivalents.

What is claimed is:

1. A seam forming system, for use in joining first and second edge regions of at least a first piece of product material, said seam forming system comprising:
at least a first planar seam forming member having a first side and a second side and a first end and a second end, wherein a portion of said first side of said at least a first planar seam forming member proximate said first end is configured for forming a seam joint between said portion of said first side proximate said first end of said at least a first planar seam forming member and a first edge region of said at least a first product material, and wherein a portion of said first side of said at least a first planar seam forming member proximate said second end is configured for forming a seam joint between said portion of said first side of said at least a first planar seam forming member proximate said second end of said at least a first planar seam forming member and a second edge region of said at least a first product material.

2. The seam forming system of claim 1 further including a second piece of product material and a second planar seam forming member, said second planar seam forming member having a first side and a second side and a first end and a second end, wherein a portion of said first side of said second planar seam forming member proximate said first end is configured for forming a seam joint between said portion of said first side proximate said first end of said second planar seam forming member and a first edge region of said second piece of product material, and wherein a portion of said first side of said second planar seam forming member proximate said second end is configured for forming a seam joint between said portion of said first side of said second planar seam forming member proximate said second end of said second planar seam forming member and a second edge region of said second piece of product material.

3. The seam forming system of claim 1, wherein said seam joint between said portion of said first side proximate said first end of said at least a first planar seam forming member and a first edge region of said at least a first product material and said seam joint between said portion of said first side of said at least a first planar seam forming member proximate said second end of said at least a first planar seam forming member and a second edge region of said at least a first product material are formed from a method selected from the group of seal forming methods consisting of radio frequency, ultrasonic, heat or other types of welding, and adhesive or chemical based bonding.

4. The seam forming system of claim 2, wherein said seam joint between said portion of said first side proximate said first end of said second planar seam forming member and a first edge region of said second product material and said seam joint between said portion of said first side of said second planar seam forming member proximate said second end of said second planar seam forming member and a second edge region of said second product material are formed from a method selected from the group of seal forming methods consisting of radio frequency, ultrasonic, heat or other types of welding, and adhesive or chemical based bonding.

5. A seam forming method for use in joining a first edge and a second edge of material to be joined together, said seam joining method comprising the acts of:
providing at least a first planar seam forming member having a first side and a second side and a first end and a second end, wherein a portion of said first side of said at least a first planar seam forming member proximate said first end is configured for forming a seam joint between said portion of said first side proximate said first end of said at least a first planar seam forming member and a first edge region of said at least a first product material, and wherein a portion of said first side of said at least a first planar seam forming member proximate said second end is configured for forming a seam joint between said portion of said first side of said at least a first planar seam forming member proximate said second end of said at least a first planar seam forming member and a second edge region of said at least a first product material;
joining said first end of said at least a first planar seam forming member to said first edge region of said at least a first product material; and
joining said second end of said at least a first planar seam forming member to said second edge region of said at least a first product material.

6. The seam joining method of claim 5, wherein said act of joining said seam joining element to said first and second end of said at least a first product member includes radio frequency, ultrasonic, heat or other types of welding, and adhesive or chemical based bonding.

7. The seam joining method of claim 5, further including the act of providing a second piece of product material and a second planar seam forming member, said second planar seam forming member having a first side and a second side and a first end and a second end, wherein a portion of said first side of said second planar seam forming member proximate said first end is configured for forming a seam joint between said portion of said first side proximate said first end of said second planar seam forming member and a first edge region of said second piece of product material, and wherein a portion of said first side of said second planar seam forming member proximate said second end is configured for forming a seam joint between said portion of said first side of said second planar seam forming member proximate said second end of said second planar seam forming member and a second edge region of said second piece of product material;
joining said first end of said second planar seam forming member to said first edge of said second edge region of said second piece of product material; and
joining said second end of said second planar seam forming member to said second edge of said second piece of product material.
